(19) United States
(12) Patent Application Publication
(10) Pub. No.: US 2002/0149253 A1
(43) Pub. Date: Oct. 17, 2002

(54) Novel seating apparatus

(76) Inventor: Glen MacDonald, Indianapolis, IN (US)

Correspondence Address: Thomas A. Walsh, ICE MILLER, One American Square, Box 82001, Indianapolis, IN, 46282-0002, US

(21) Appl. No.: 09/835,159

(22) Filed: Apr. 14, 2001

(51) Int. Cl. B60N 2/24

(52) U.S. Cl. 297/452.14

(57) ABSTRACT

A novel seating apparatus enabling rapid removal of an injured occupant from a vehicle in which the apparatus is installed. The occupant sits in the apparatus as he operates the vehicle. Thus, the apparatus is in place in the event of an accident involving injury to the occupant, reducing post-injury maneuvering of the injured occupant, and the risk of injury exacerbation associated therewith.

The apparatus comprises an anatomically formed sheet of thermoplastic material beginning beneath the occupant's buttocks, extending continuously beneath and behind the occupant, and terminating behind the back of the occupant. The apparatus includes a plurality of extraction points sufficient in number and positioned to permit extraction of the occupied seating apparatus from the vehicle with minimal movement of the occupant relative to the apparatus during extraction. A lifting force is applied to the extraction points to cause the occupied apparatus to be extracted from the vehicle.

### BACKGROUND

In all forms of automobile racing, and particularly in open wheel automobile racing such as that sanctioned by CHAMPIONSHIP AUTO RACING TEAMS® (“CART®”) or the INDY RACING LEAGUE® (“IRL®”), the quest for additional speed dictates that aerodynamic measures be incorporated into the design of the automobile. For example, to reduce the effect of wind resistance on the automobile, it is desirable that the cockpit of an open wheel racing automobile be as narrow as possible across its longitudinal axis.

However, considerations of aerodynamics and speed, while important, are not absolute. Automobile racing is a dangerous sport. Accidents occur frequently and, due to the high rate of speed and the inelasticity of the objects into which a racing automobile may collide, considerations of driver safety also are important. Racing automobile designers and manufacturers face important decisions in overcoming the conflicts that may arise between design features which enhance aerodynamics and speed and those which enhance driver safety.

One area in which the judgment of racing automobile designers and manufacturers with respect to such conflicts may be observed is in the design and manufacture of racing automobile seats. To illustrate the point, it is useful to first compare racing automobile seat design and manufacture to passenger automobile seat design and manufacture.

It is well known in the art of passenger automobile seat design and manufacture that a passenger automobile seat is designed to be mass-produced for use by human occupants comprising a broad spectrum of anatomical shapes and sizes. Customization of the seat is not economically feasible. In addition, such seats are designed to be assembled outside of the passenger compartment of the automobile, moved into the passenger compartment through a doorway, and then fastened in place inside the passenger compartment of the automobile. Passenger automobile seats are designed primarily for comfort and manufactureability, with safety receiving a lesser consideration. Such a tradeoff between comfort, manufactureability, and safety is reasonable in light of the intend use of such seats and the environment in which they will be used. For example, passenger automobiles typically travel at a relatively low rate of speed when compared to racing vehicles. The framework of a passenger automobile normally is constructed of heavy, impact absorbing materials, and the occupants typically are not positioned directly adjacent to the framework where they may be in jeopardy of violently colliding with the framework in the event of an accident.

In contrast, it is known in the art of racing automobile seat design and manufacture to custom fit the seat to the occupant and to fabricate the seat from materials selected for their impact-absorbing properties. The configuration of the framework of a racing automobile cockpit often mandates that the seat be fabricated inside the racing automobile cockpit. It also is known in the art of racing automobile seat design and manufacture that a custom-fit seat fabricated from impact absorbing materials will reduce the probability that an automobile race driver will be injured in an automobile racing accident. When a custom-fit seat is used in conjunction with a properly fitted racing seat belt harness, the torso of the driver will be substantially immobilized relative to the seat in the event of an accident. Thus, the driver also will be substantially immobilized relative to the framework of the racing automobile, reducing the chance of a potentially concussive impact between the driver and the framework of the racing automobile. In addition, the impact-absorbing materials comprising the automobile racing seat will absorb a substantial component of the force of the impact, with the custom fit of the seat distributing the component of the force which is not absorbed by the seat across a broad surface area of the driver's body.

One technique known in the art of automobile racing seat design and manufacture, and frequently used in racing seats used in open wheel racing automobiles such as those used in CART® or IRL®, is to manufacture a custom-fit racing seat from impact absorbing beads comprising polystyrene or polypropylene. Such beads are installed in a plastic covering. The interstitial spaces between the beads are filled with a resin material, substantially displacing the air inside the plastic covering. The mixture comprising the beads and resin is held under a vacuum within the plastic covering, and the eventual occupant of the seat is seated therein. The occupant's body weight displaces the bead/resin mixture within the plastic covering, such that the mixture within the plastic covering conforms to the anatomical shape of the occupant, providing the custom fit so important to the occupant's safety. When the resin cures, the seat retains the anatomical shape of the occupant. The bead/resin mixture provides a racing seat with impact absorbing resiliency.

It also is known in the art of automobile racing seat design and manufacture to provide a custom-fit seating insert constructed from carbon fiber or KEVLAR®. Such a seating insert is fabricated to conform to the anatomy of its eventual occupant. It fits inside the custom-fit automobile racing seat and is fastened to the automobile racing seat and/or to the frame of the racing automobile. Because of the expensive materials and processes, a carbon fiber or KEVLAR® seating insert is costly to fabricate, with some costing in excess of $25,000. In addition, the fabrication processes require that such a seating insert is fabricated outside the racing automobile cockpit in two or more pieces, and then inserted into the cockpit and joined together. Such a seating insert is rigid, and because of the custom fit and rigidity, supplements the protection afforded to the occupant by the impact-absorbing racing seat.

Despite the safety features designed into racing automobiles and racing seats, automobile racing is still dangerous, and drivers may be injured. Such injuries may include injuries to the spinal column of the driver. Those skilled in the emergency medicine art will appreciate that the appropriate first aid for a possible spinal cord injury includes immobilization of the spinal column.

A problem arises, however, because of the configuration of the racing automobiles, particularly in open wheel racing such as that sanctioned by CART® or IRL®. The driver's seat cannot be extracted with the driver remaining therein, so it is difficult to remove an injured driver without a risk of exacerbating movement of the injured spinal cord. It is known in the art to use a backboard device to assist in immobilizing a driver's spinal column during extraction. The backboard device is inserted behind and beneath the injured driver, and then the driver and backboard device are lifted together from the automobile. Unfortunately, the torso of the injured driver necessarily must be maneuvered to insert the backboard device between the injured driver and the racing seat. Such maneuvering may exacerbate an injured spinal column. In addition, the time spent maneuvering the backboard device into position delays more comprehensive medical attention to the driver's injuries.

For the foregoing reasons, it is desired to provide an apparatus that will enable racetrack safety crews to rapidly remove an injured race driver, without requiring post-injury maneuvering of the injured race driver for placement of the apparatus. In addition, it is desired to provide an apparatus that will reduce the time required to extract an injured race driver from a racing automobile in the event of an accident. Such an apparatus is desired to be economical to manufacture and lightweight, yet rigid enough that when lifted at appropriate points, the apparatus will support the weight of the injured driver without substantially flexing.

### SUMMARY

The present invention is a novel seating apparatus providing support to an occupant and enabling rapid removal of an injured occupant from a vehicle in which the apparatus is installed. During operation of the vehicle, a seating apparatus according to the present invention resides beneath and behind its occupant, between the occupant and the vehicle seat. The seating apparatus according to the present invention is in contact with both the occupant and the vehicle seat during operation of the vehicle. In one embodiment of the present invention, the vehicle is a racing automobile, the vehicle seat is a custom-fit racing seat, and the occupant is the race driver.

Because the occupant is seated in the seating apparatus as he or she operates a racing automobile, or operates or rides in another form of vehicle, the apparatus is in place and ready for use in the event of an accident involving injury to the occupant. Thus, the need for post-injury maneuvering of the injured occupant, and the risk of injury exacerbation associated therewith, are reduced or eliminated by use of the present invention. In addition, pre-placement of the seating apparatus, in combination with the use of extraction points and lifting means according to the present invention, may significantly reduce the time required to extract an injured occupant, permitting prompt medical attention to the occupant's injuries. Finally, because the present invention may be fabricated from a readily available thermoplastic material, the present invention is economical to manufacture and lightweight, yet rigid enough that when lifted at appropriate points, it supports the weight of the injured occupant without substantially flexing.

One embodiment of the present invention comprises a sheet of a thermoplastic material anatomically formed to fit its occupant. In this embodiment, the seating apparatus begins at a lower edge beneath the buttocks of the occupant, extends continuously beneath and behind the occupant, and terminates at an upper edge behind the back of the occupant. This embodiment of the present invention also comprises a plurality of integral extraction points, the extraction points being sufficient in number and appropriately positioned to permit extraction of the occupied apparatus from a vehicle with minimal movement of the occupant relative to the apparatus during extraction. A lifting means may be engaged with each of the plurality of extraction points. When a lifting force is applied to the lifting means, the occupied seating apparatus is caused to be extracted from the vehicle.

These and other features and advantages of the present invention, and the manner of attaining them, will be more apparent and better understood by reference to the following descriptions of embodiments of the invention taken in conjunction with the accompanying drawings and with the appended claims.

### BRIEF DESCRIPTION OF THE DRAWINGS

FIG. 1A shows an upper right perspective view of one embodiment of an unoccupied seating apparatus according to the present invention.

FIG. 1B shows a front elevational view of the embodiment shown in FIG. 1A.

FIG. 2A shows an upper right perspective view of one embodiment of an unoccupied seating apparatus according to the present invention.

FIG. 2B shows a front elevational view of the embodiment shown in FIG. 2A.

FIG. 3A shows a front elevational view of an embodiment of a seating apparatus template according to the present invention.

FIG. 3B shows a front elevational view of an embodiment of a seating apparatus template according to the present invention

FIG. 4 shows a flow chart illustrating a process for fabricating a seating apparatus according to one embodiment of the present invention.

FIG. 5A shows a front elevational view of one embodiment of a seating apparatus according to the present invention, illustrating a possible configuration for the extraction points.

FIG. 5B shows a front elevational view of one embodiment of a seating apparatus according to the present invention, illustrating a possible configuration for the extraction points.

FIG. 6A shows a cutaway side view of a seating apparatus according to the present invention, illustrating the use of an extraction device affixed to the seating apparatus.

FIG. 6B shows a front elevational view of the extraction device of FIG. 6A, with lifting means according to the present invention engaged therewith.

FIG. 6C shows a cutaway side view of a seating apparatus according to the present invention, illustrating the use of an extraction device affixed to the seating apparatus.

FIG. 6D shows a front elevational view of the extraction device of FIG. 6C, with lifting means according to the present invention engaged therewith.

FIG. 7A shows a top view of one embodiment of a lifting harness according to the present invention.

FIG. 7B shows a top view of one embodiment of a lifting harness according to the present invention.

FIG. 7C shows a top view of one embodiment of a lifting harness according to the present invention.

FIG. 7D shows a top view of one embodiment of a lifting harness according to the present invention.

FIG. 8 shows a cutaway side view of a lifting means according to the present invention, illustrating the use of a clip affixed to the lifting means.

### DESCRIPTION

The present invention is a novel seating apparatus providing support to an occupant and enabling rapid removal of an injured occupant from the vehicle in which the apparatus is installed. Because the occupant is seated in the seating apparatus as he or she operates a racing automobile, or operates or rides in another form of vehicle, the apparatus is in place and ready for use in the event of an accident involving injury to the occupant. Thus, the need for post-injury maneuvering of an injured occupant, and the risk of injury exacerbation associated therewith, are reduced or eliminated by use of the present invention.

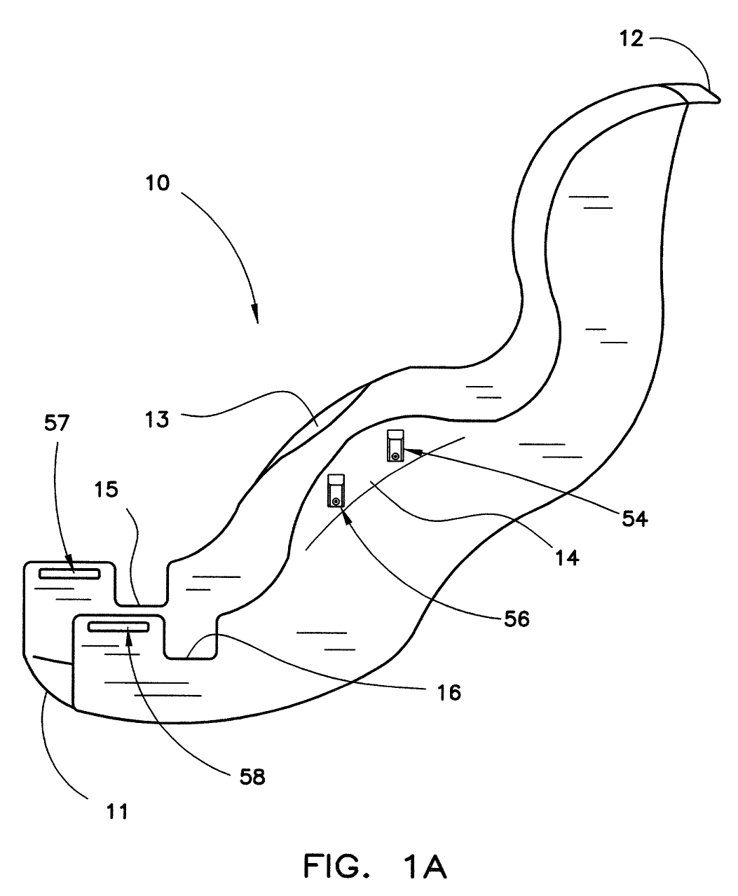

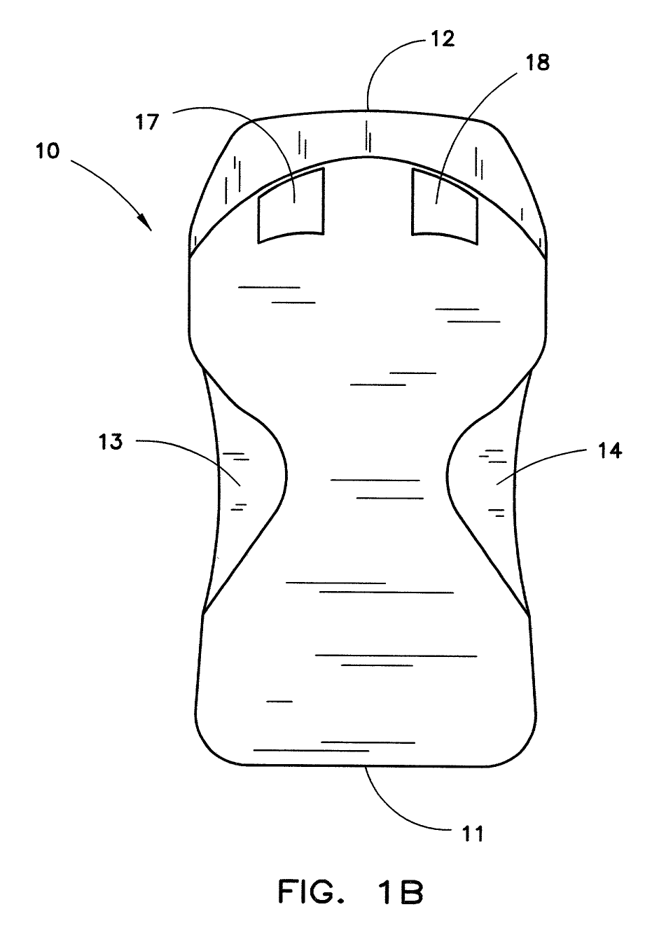

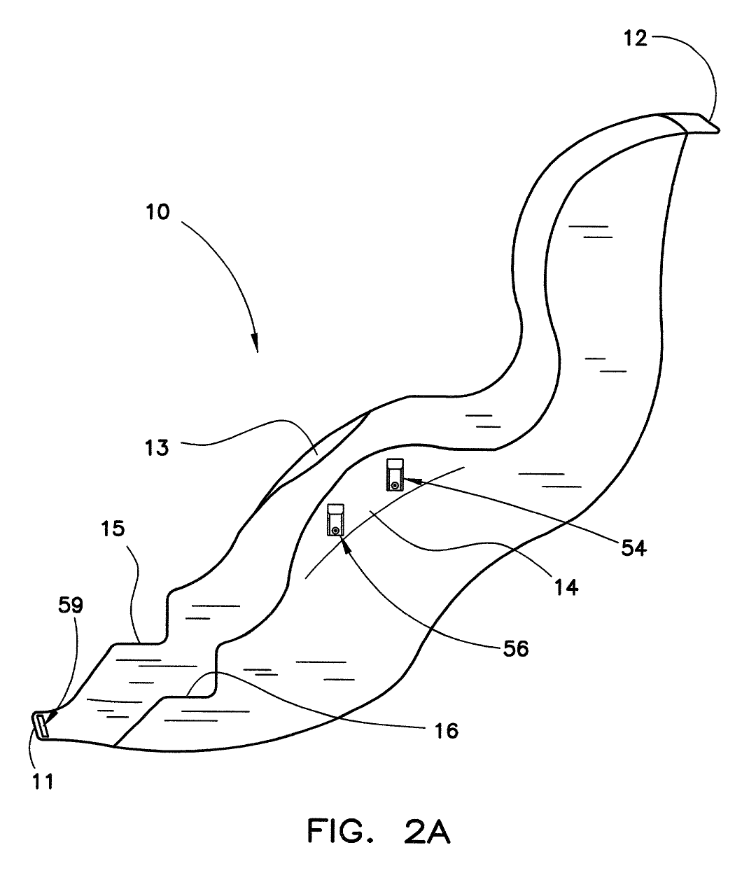

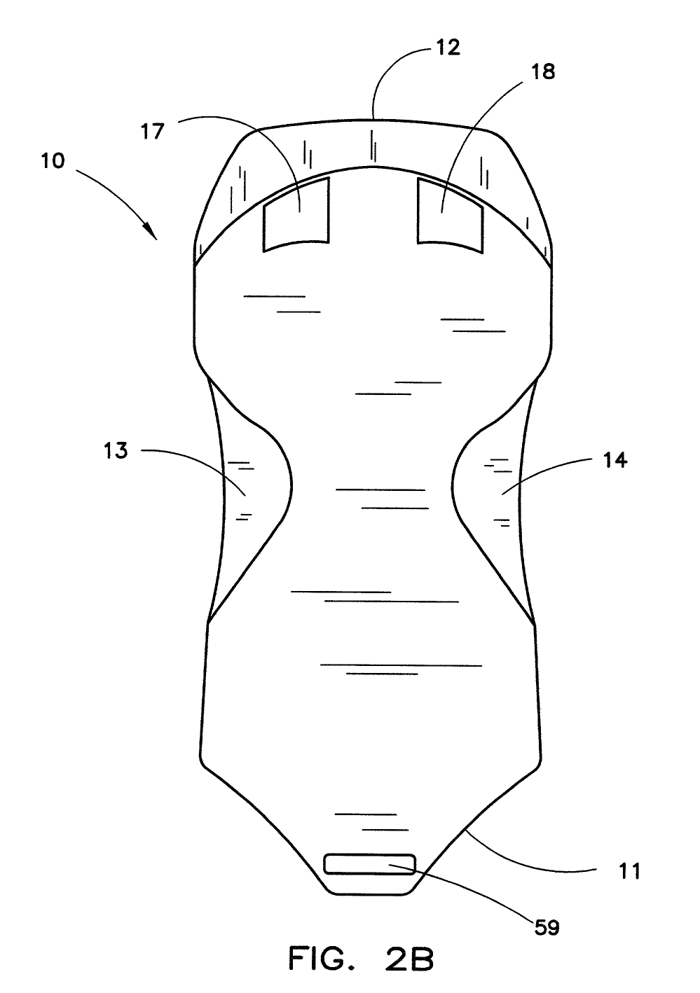

FIG. 1A shows an upper right perspective view of an embodiment of an unoccupied seating apparatus 10 according to the present invention. FIG. 1B shows a front elevational view of the embodiment of seating apparatus 10 shown in FIG. 1A. FIG. 2A shows an upper right perspective view of another embodiment of an unoccupied seating apparatus 10 according to the present invention. FIG. 2B shows a front elevational view of the embodiment of seating apparatus 10 shown in FIG. 2A.

During operation of the racing automobile, seating apparatus 10 resides beneath and behind its occupant, the driver, between the occupant and the automobile racing seat. Seating apparatus 10 of the present invention is in contact with both the occupant and the automobile racing seat during operation of the racing automobile. Seating apparatus 10 of the present invention is compatible with all seat belt configurations, including without limitation the five-point and six-point seat belt harness configurations widely used in automobile racing.

A seating apparatus according to the present invention must be appropriately sized and constructed to permit extraction of the complete seating apparatus from an automobile racing seat with its occupant remaining therein, and with minimal movement of the occupant relative to the seating apparatus during extraction. In one embodiment, seating apparatus 10 is a flexibly rigid seating apparatus constructed from a single sheet of thermoplastic material, such as, for example, the thermoplastic material sold by North Coast Medical, Inc. under the trade name OMEGA MAX™. Other thermoplastic materials with properties of stretch resistance, rigidity, and bonding which are comparable to those possessed by OMEGA MAX™ may be used. To support the weight of a human occupant during extraction, a thermoplastic material thickness of at least one-eighth inch (⅛″) is preferred.

In the embodiments shown in FIGS. 1A-B and 2A-B, seating apparatus 10 begins at lower edge 11, and extends continuously until terminating at upper edge 12, which is approximately level with the eventual occupant's shoulders. Right thoracic lobe 13 and left thoracic lobe 14 of seating apparatus 10 are shaped so as to engage respectively against the right side and left side of the thorax of the occupant. When used herein in association with the thoracic lobes or other features of seating apparatus 10 or seating apparatus template 30, the designations “right” and “left” are made in reference to the position of the eventual occupant of the seating apparatus.

Shown in FIGS. 1A and 2A are a right lap belt channel 15 and a left lap belt channel 16. The right and the left lap belt channels are sized and positioned to receive the lap belt components of the racing automobile's seat belt harness in a manner which will not interfere with the normal function of the lap belts or the other components of the seat belt harness. Also shown are extraction points 54, 56, 57, and 58 in FIG. 1A, and extraction points 54, 56, and 59 in FIG. 2A. Extraction points are discussed in further detail hereinafter.

Shown in FIGS. 1B and 2B are a right shoulder belt channel 17 and a left shoulder belt channel 18. The left and the right shoulder belt channels are sized and positioned to receive the shoulder belt components of the racing automobile's seat belt harness in a manner which will not interfere with the normal function of the shoulder belts or the other components of the seat belt harness. Also shown is extraction point 59 in FIG. 2B. Extraction points are discussed in further detail hereinafter.

Lower edge 11 of seating apparatus 10 must extend at least beneath the buttocks of the occupant in a manner and to an extent sufficient to enable the occupant to be securely lifted inside the seating apparatus and extracted from a racing automobile or other vehicle, with minimal movement of the occupant relative to the seating apparatus during extraction. Preferably, lower edge 11 of seating apparatus 10 does not interfere with normal operation of occupant's knee joint.

In one embodiment of the present invention, upper edge 12 of seating apparatus 10 is approximately level with the occupant's shoulders, but such a location is not required for a seating apparatus to be within the scope of the present invention. It is only required that seating apparatus 10 extends behind the occupant's back in a manner and to an extent sufficient to enable the occupant to be securely lifted inside the seating apparatus and extracted from a racing automobile or other vehicle, with minimal movement of the occupant relative to the seating apparatus during extraction, and with minimal movement of occupant's lumbar and lower thoracic vertebrae relative to each other. Preferably, upper edge 12 of seating apparatus 10 does not interfere with normal movement of occupant's neck.

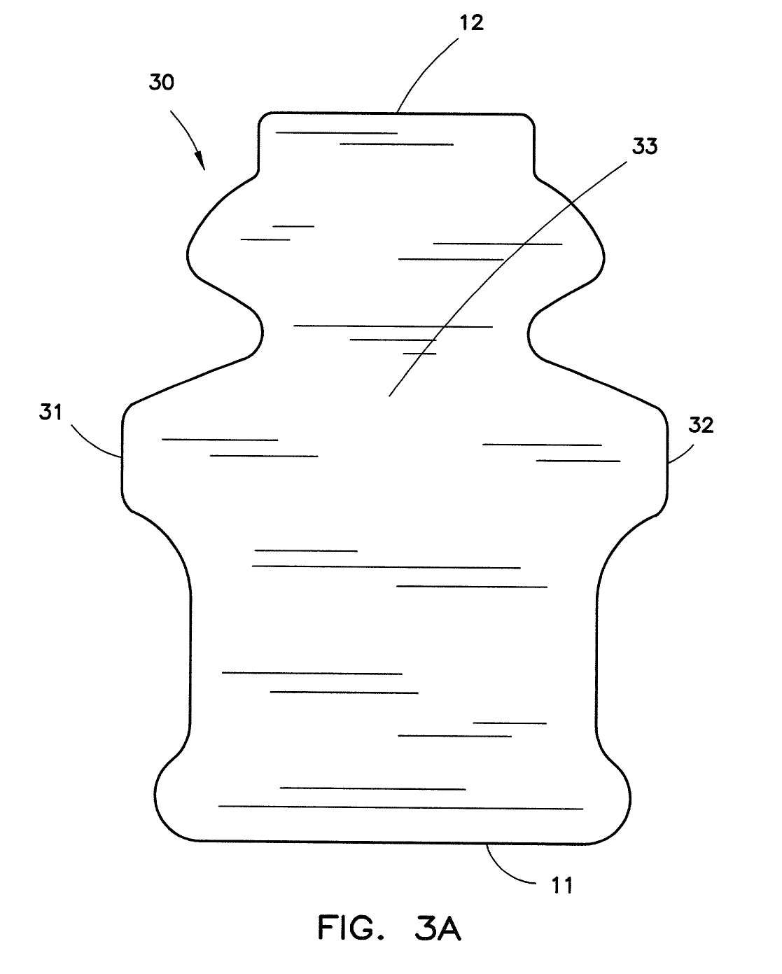

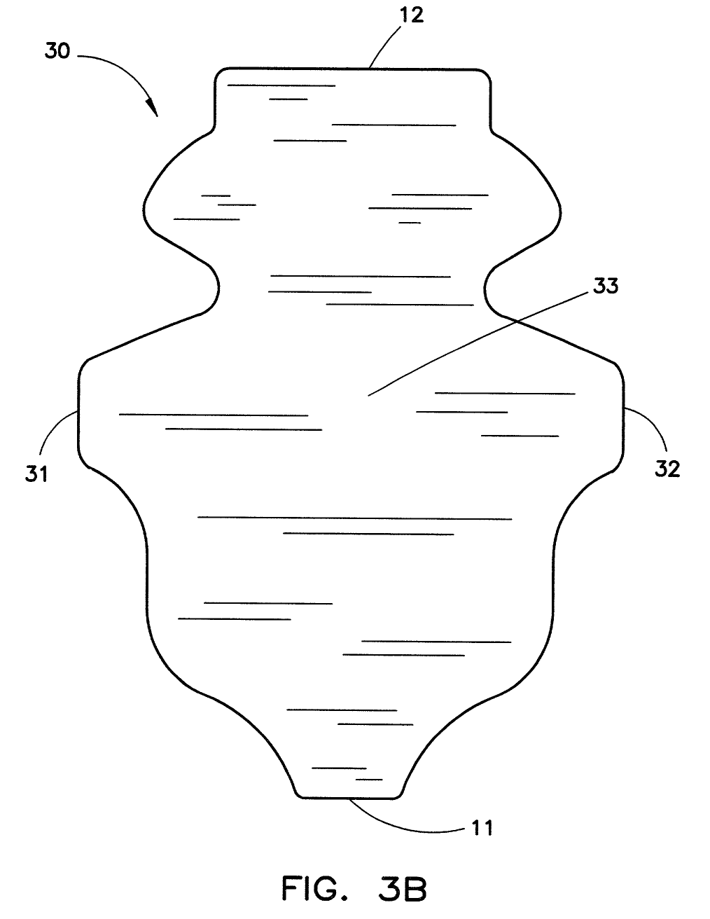

FIG. 3A shows a front elevational view of an embodiment of seating apparatus template 30 according to the present invention which, after the fabrication steps discussed hereinafter, comprises the embodiment of seating apparatus 10 shown in FIG. 1A. FIG. 3B shows a front elevational view of another embodiment of seating apparatus template 30 according to the present invention which, after the fabrication steps discussed hereinafter, comprises the embodiment of seating apparatus 10 shown in FIG. 2A.

Seating apparatus template 30 is shown as having lower edge 11, upper edge 12, right thoracic lobe 31, left thoracic lobe 32, and anterior template surface 33. Posterior template surface 34 (not shown in FIGS. 3A-B) comprises the surface of seating apparatus template 30 opposite to anterior template surface 33. Anterior template surface 33 and posterior template surface 34 are substantially parallel, and are separated by the thickness of the material comprising seating apparatus template 30.

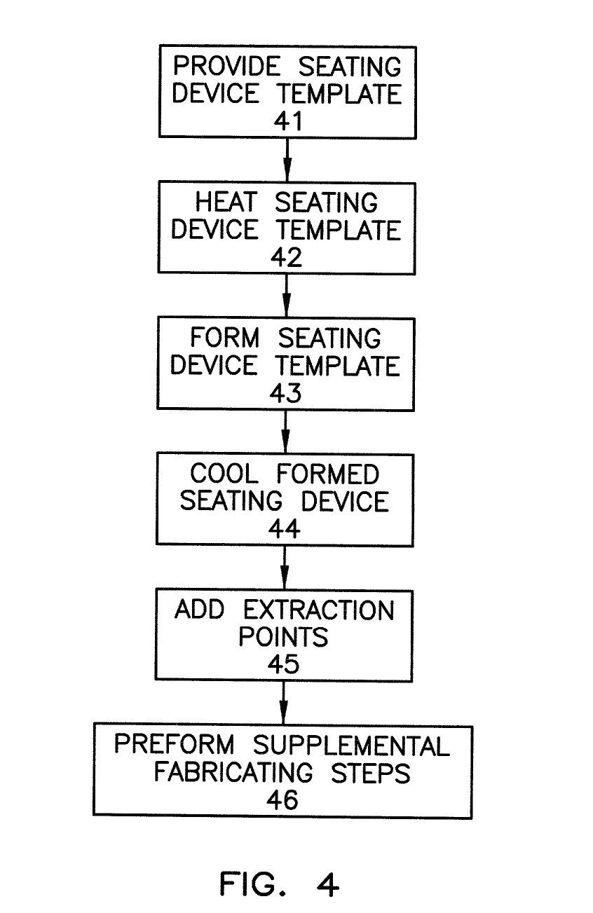

A seating apparatus according to one embodiment of the present invention may be fabricated according to the method shown in FIG. 4. At block 41 of FIG. 4, a seating apparatus template comprising a sheet of thermoplastic material of a desired thickness is provided. The seating apparatus template is sized so that after heating, forming, and cooling (as hereinafter described) seating apparatus 10 will extend beneath the occupant's buttocks and behind the occupant's back in a manner and to an extent sufficient to permit extraction of the complete seating apparatus from an automobile racing seat with its occupant remaining therein, and with minimal movement of the occupant relative to the seating apparatus during extraction.

At block 42 of FIG. 4, seating apparatus template 30 is exposed to a heat source causing the temperature of seating apparatus template 30 to be elevated to at least above the temperature at which the material comprising seating apparatus template 30 becomes formable. In one embodiment, where the material comprising seating apparatus template 30 comprises OMEGA MAX™, seating apparatus template 30 is heated to at least 180° F. by immersion in water which has been heated to at least that temperature. Because the OMEGA MAX™ material tends to adhere to itself when heated, in certain implementations of the present invention one practicing this step of the method shown in FIG. 4 may find it beneficial to add a small amount of dishwashing soap, such as that sold by the Colgate-Palmolive Company under the trade name PALMOLIVE®, to the water prior to immersing the OMEGA MAX™ material therein. This technique inhibits the self-adherence property of the OMEGA MAX™ material. After the seating apparatus template 30 comprising the OMEGA MAX™ material has reached a temperature of at least 180° F., it is removed from the water.

At block 43 of FIG. 4, while the temperature of seating apparatus template 30 remains elevated to at least a temperature at which the material comprising seating apparatus template 30 is formable, seating apparatus template 30 is formed to fit the anatomy of its eventual occupant. In one implementation of the present invention, seating apparatus template 30 is placed over an automobile racing seat, with posterior template surface 34 facing the seating surface of the automobile racing seat. Seating apparatus template 30 is positioned over the automobile racing seat so that, after forming and cooling, seating apparatus 10 will extend beneath the occupant's buttocks and behind the occupant's back in a manner and to an extent sufficient to permit extraction of the complete seating apparatus from an automobile racing seat with its occupant remaining therein, and with minimal movement of the occupant relative to the seating apparatus during extraction.

After seating apparatus template 30 is properly positioned over the automobile racing seat, the occupant is seated thereon. The occupant's torso and lower extremities engage anterior template surface 33 and the occupant's body weight forces seating apparatus template 30 against the surface of the automobile racing seat. The occupant's body weight causes posterior template surface 34 to be deformed convexly until it comes into contact with the surface of the automobile racing seat. Anterior template surface 33 remains in engagement with the occupant's torso and lower extremities, and thereby is deformed concavely. If not sufficiently formed through the application of the occupant's body weight, right thoracic lobe 31 and left thoracic lobe 32 are formed around the thorax of the occupant through the application of forming pressure causing the anterior surface of each thoracic lobe to become engaged against the occupant's thorax.

At block 44 of FIG. 4, the formed seating apparatus 10 is permitted to cool to a temperature below which it no longer is formable, and then is removed from the occupant and the racing seat. The cooled, formed seating apparatus 10 retains its shape when removed from the occupant and the racing seat.

At block 45 of FIG. 4, a plurality of extraction points are added to the formed seating apparatus 10. The present invention requires that the extraction points must be sufficient in number and appropriately positioned to permit extraction of the complete seating apparatus from an automobile racing seat with its occupant remaining therein, and with minimal movement of the occupant relative to the seating apparatus during extraction. The actual number of extraction points to be used, and the positioning thereof, is left to the discretion of the practitioner in each implementation of the seating apparatus.

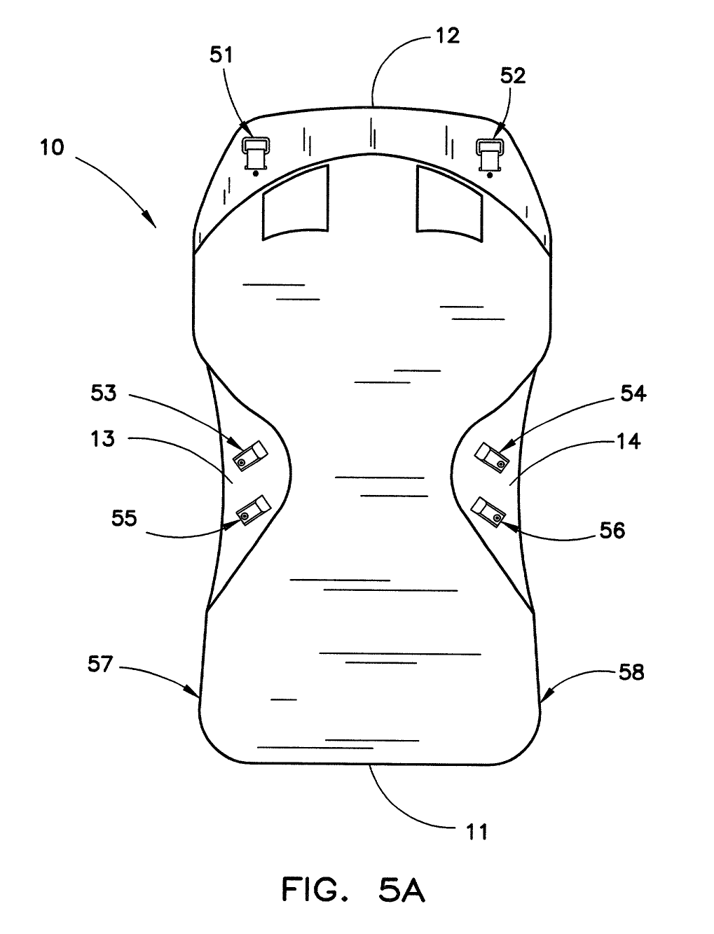

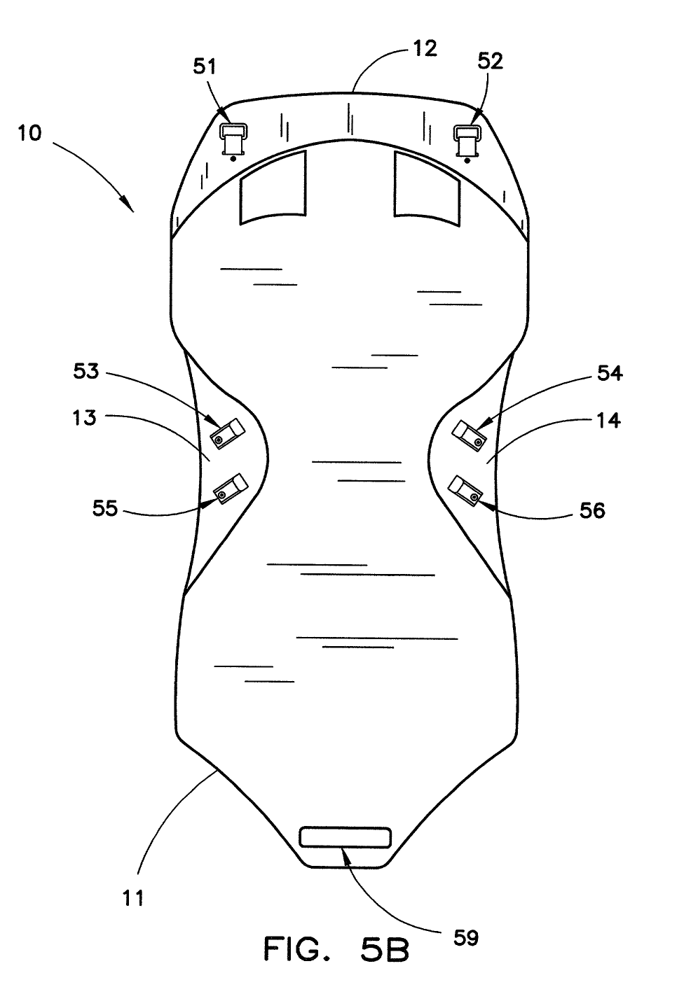

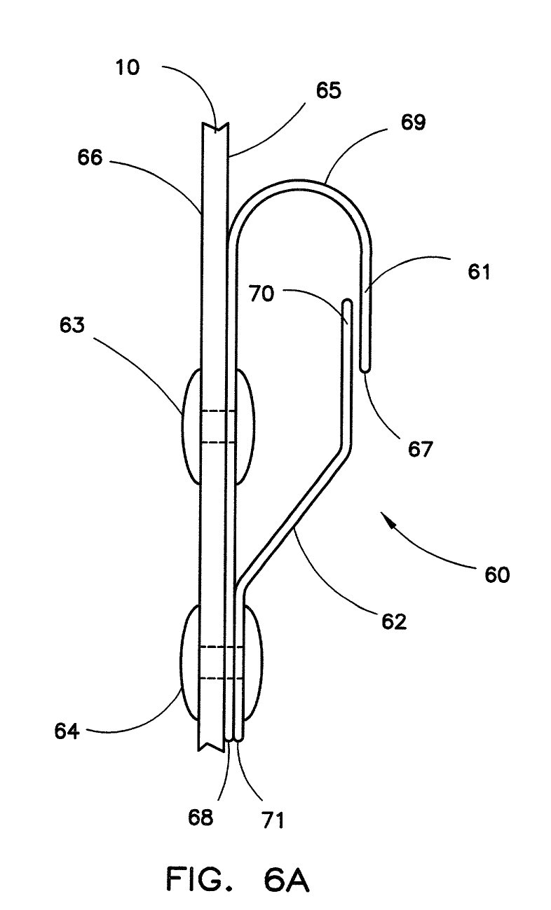

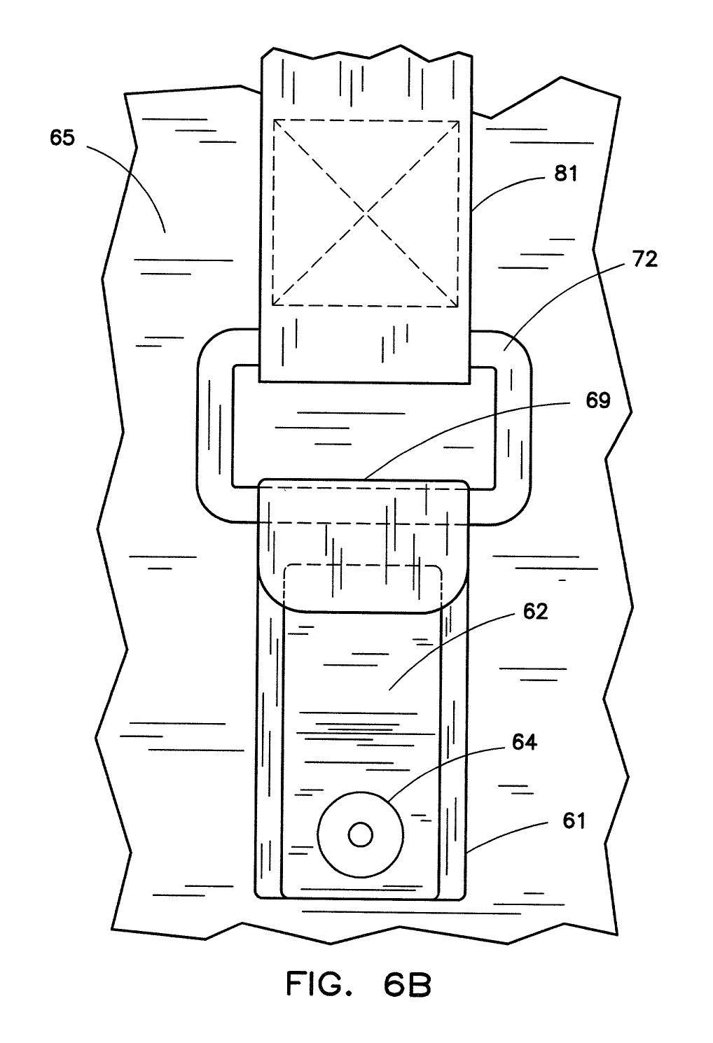

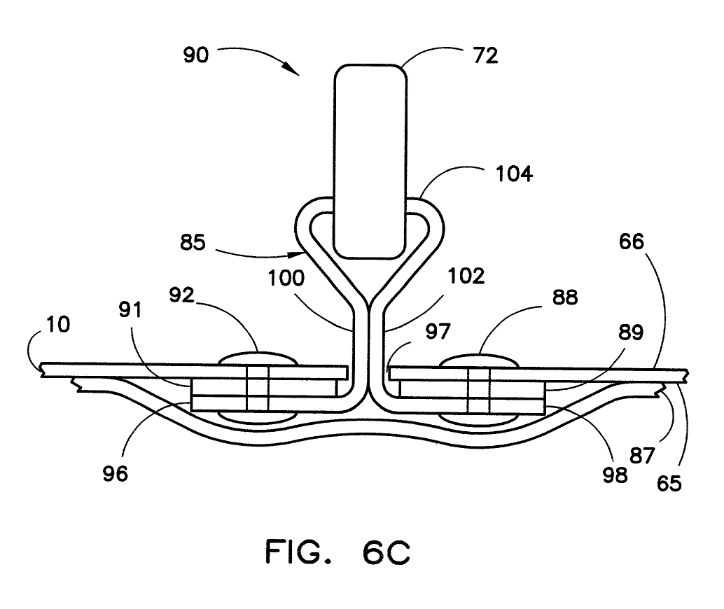

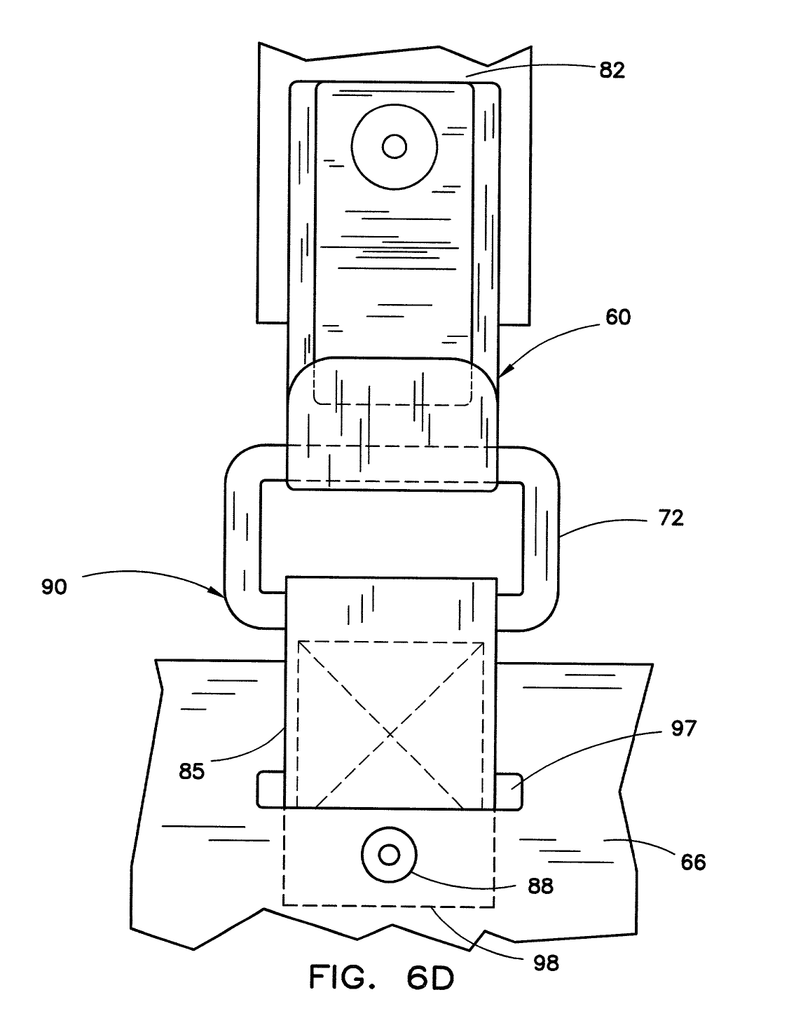

In one embodiment of seating apparatus 10 according to the present invention, the extraction points are as shown in FIG. 5A. Shown in FIG. 5A are extraction points 51 and 52 positioned on seating apparatus 10 near upper edge 12, extraction points 53 and 55 positioned laterally on seating apparatus 10 near right thoracic lobe 13, extraction points 54 and 56 positioned laterally on seating apparatus 10 near left thoracic lobe 14, and extraction points 57 and 58 positioned laterally on seating apparatus 10 near lower edge 11. By way of example and not limitation, extraction points 51 and 52 are shown in FIG. 5A as comprising a strap and ring extraction device such as extraction device 90 of FIG. 6C, and extraction points 53, 54, 55, and 56 are shown in FIG. 5A as comprising a clip extraction device such as clip 60 of FIG. 6A.

In another embodiment of seating apparatus 10 according to the present invention, the extraction points are as shown in FIG. 5B. Shown in FIG. 5B are extraction points 51 and 52 positioned near upper edge 12, extraction points 53 and 55 positioned laterally on seating apparatus 10 near right thoracic lobe 13, extraction points 54 and 56 positioned laterally on seating apparatus 10 near left thoracic lobe 14, and extraction point 59 positioned near the center of lower edge 11. By way of example and not limitation, extraction points 51 and 52 are shown in FIG. 5B as comprising a strap and ring extraction device such as extraction device 90 of FIG. 6C. By way of example and not limitation, extraction points 53, 54, 55, and 56 are shown in FIG. 5B as comprising a clip extraction device such as clip 60 of FIG. 6A. By way of example and not limitation, extraction point 59 is shown in FIG. 5B as comprising a manually engageable extraction point.

Referring back to FIG. 4, at block 46 thereof optional supplemental fabrication steps may be performed. For example, seating apparatus 10 may be trimmed to remove excess material. Where the formed seating apparatus comprises a thermoplastic material such as the OMEGA MAX™ material, trimming may be accomplished by one of many means known in the art, including, for example, using a single blade cutting means such as a knife or a scalpel, or using opposing blade cutting means such as shears, scissors, and the like.

Also at block 46 of FIG. 4, where the forming step of block 43 of FIG. 4 did not result in a proper fit of the seating apparatus between the occupant and the racing seat, localized forming may be performed. Localized forming is accomplished by directing a heat source toward an area of the formed seating apparatus that is smaller than the complete seating apparatus (a “localized area”). The temperature of the localized area thereby is caused to be elevated above the temperature at which the localized area becomes formable. Where the material comprising seating apparatus 10 comprises OMEGA MAXTM, the localized area is heated to at least 180° F. using, for example, a heat gun or other tool capable of causing the temperature of the localized area to become elevated. While the temperature of the localized area remains elevated to at least above the temperature at which it is formable, pressure may be applied to the localized area to form it into the desired shape.

Also at block 46 of FIG. 4, seating apparatus 10 may be ruggedized by adding one or more layers of thermoplastic material to desired areas of the seating apparatus. “Ruggedization” refers to measures taken to increase the strength of the seating apparatus and/or portions of the seating apparatus. Ruggedization may be desirable to reduce the probability that the thermoplastic material comprising the seating apparatus will distort or rupture during extraction of the occupied seating apparatus. Ruggedization is optional and is left to the discretion of the practitioner in each implementation of the present invention. The entire apparatus may be ruggedized, or the practitioner may desire to ruggedize only a localized area. For example, the practitioner may desire to ruggedize the thoracic region of the seating apparatus. To accomplish this, at least one piece of thermoplastic material sized and shaped to match the area of the seating apparatus to be ruggedized is provided. The appropriately sized and shaped piece of thermoplastic material is exposed to a heat source causing the temperature of the piece of thermoplastic material to be elevated to at least above the temperature at which the thermoplastic material becomes formable.

In one embodiment, where the thermoplastic material comprises OMEGA MAX™, the piece of thermoplastic material is heated to at least 180° F. by immersion in water which has been heated to at least that temperature, or by exposure to a hot air gun or other heat source. After the piece of thermoplastic material comprising the OMEGA MAX™ material has reached a temperature of at least 180° F., it is removed from the water, or removed from proximity to the hot air gun or other heat source, and applied to the surface of the seating apparatus. At the discretion of the practitioner, the piece of thermoplastic material may be applied either to the anterior surface or to the posterior surface of the seating apparatus. Where the material comprises OMEGA MAX™, the bonding properties of the OMEGA MAX™ material will cause the heated piece of thermoplastic material to bond to the selected anterior or posterior surface of the seating apparatus, thereby ruggedizing an area of the seating apparatus substantially the same size as the area of the ruggedizing piece. The region of the seating apparatus comprising the additional ruggedizing layer of thermoplastic material will be less prone to rupture or distortion than a non-ruggedized region.

Those skilled in the art will appreciate that certain of the steps shown in FIG. 4 may be performed in a different sequence while accomplishing the same result. For example, it may be possible to add the extraction points to seating apparatus template 30 before it is heated and formed. In addition, it may be possible to perform certain supplemental fabrication steps such as, for example, trimming excess material or forming a localized area, before the extraction points are added to the seating apparatus.

Referring back to block 45 of FIG. 4, in one embodiment the extraction points comprise apertures made through the formed seating apparatus 10. Where the formed seating apparatus comprises a thermoplastic material such as the OMEGA MAX™ material, the apertures are made through the formed seating apparatus using one of many means known in the art for forming an aperture through a sheet of thermoplastic material, including, for example, using single blade cutting means such as a knife or a scalpel, or using opposing blade cutting means such as shears, scissors, and the like.

If so desired by the practitioner, one or more extraction points may be provided for engagement with a human hand in an implementation of a seating apparatus according to the present invention. Such a manually engageable extraction point may comprise an aperture made through the seating apparatus, or may comprise an extraction device such as a handle affixed to the seating apparatus. Referring back to FIGS. 1A and 5A, manually engageable extraction points 57 and 58 are shown. Referring back to FIGS. 1B and 5B, manually engageable extraction points manually engageable extraction point 59 is shown. Each of manually engageable extraction points 57, 58, and 59 comprises an aperture made through the seating apparatus.

Those skilled in the art also will appreciate that alternate means of providing extraction points may be used. For example, instead of apertures made through seating apparatus 10, extraction points may be provided in the form of “extraction devices” such as snaps, hooks, clips, or VELCRO® fasteners, or in the form of other extraction means known in the art. Such extraction devices or other extraction means may be affixed to the anterior surface and/or to the posterior surface of the formed seating apparatus by techniques known in the art, such as, for example, through the use of an adhesive. The adhesive is disposed between a surface of seating apparatus 10 and a surface of the extraction device or extraction means, and is permitted to cure as necessary to create an adhesive bond between the surface of seating apparatus 10 and the surface of the extraction device or extraction means. The adhesive must comprise bonding properties able to produce adhesive bonds between the extraction device or extraction means and the material comprising the formed seating apparatus 10, with such adhesive bonds collectively having a bonding strength sufficient to permit seating apparatus 10 to be extracted from the seat of a racing automobile with its occupant remaining therein, without failure of any such adhesive bond.

In addition to or in lieu of the use of an adhesive, such extraction devices or extraction means may be affixed to the material comprising seating apparatus 10 by fastening techniques known in the art including, but not limited to, riveting. Where riveting is used, the rivets must comprise fastening properties capable of fastening the extraction device or extraction means to the material comprising the formed seating apparatus 10, with such rivets collectively having a fastening strength sufficient to permit seating apparatus 10 to be extracted from an automobile racing seat with its occupant remaining therein, without failure of any such rivet.

FIG. 6A shows a cutaway side view of seating apparatus 10, illustrating the use an extraction device comprising a clip affixed to the material comprising seating apparatus 10. Shown in FIG. 6A are seating apparatus 10 comprising a first surface 65 and a second surface 66, and clip 60 comprising base member 61, flexible member 62, and rivets 63 and 64. Base member 61 comprises a small sheet of a substantially rigid material such as steel or a substantially rigid plastic or polycarbonate material. In the embodiment shown in FIG. 6A, base member 61 has a length greater than its width, but this is not required. Base member 61 comprises first end 67 and second end 68, and further comprises apertures (not shown in FIG. 6A) positioned and sized to receive rivets 63 and 64. A portion of first end 67 of base member 61 is formed across the width of base member 61 at an angle of approximately 180° to comprise rounded end 69. Rounded end 69 is internally sized to receive and retain a lifting means, as will be discussed hereinafter.

Flexible member 62 comprises a small sheet of a flexibly rigid material such as steel or a flexibly rigid plastic or polycarbonate material. In the embodiment shown in FIG. 6A, flexible member 62 has a length greater than its width, but this is not required. Flexible member 62 comprises first end 70 and second end 71, and further comprises an aperture (not shown in FIG. 6A) positioned and sized to receive rivet 64. Flexible member 62 is dimensioned and shaped so that first end 70 of flexible member 62 is proximately engaged with first end 67 of base member 61, and second end 71 of flexible member 62 is engaged against second end 68 of base member 61, as shown in FIG. 6A.

Clip 60 is affixed to seating apparatus 10 by engaging base member 61 against first surface 65 of seating apparatus 10. Next, rivet 63 is passed through an aperture in base member 61 and through the material comprising seating apparatus 10 by means well known in the art such as, for example, by use of a rivet gun. Optionally, seating apparatus 10 comprises a preformed aperture positioned and sized to receive rivet 63. Rivet 63 then is fastened against second surface 66 of seating apparatus 10, thereby fastening base member 61 against first surface 65 of seating apparatus 10. Optionally, rivet 63 may be installed from the reverse direction and then fastened against base member 61 to accomplish the same result.

Flexible member 62 then is engaged against base member 61 so that first end 70 of flexible member 62 is inside rounded end 69 of base member 61 and the aperture in flexible member 62 is aligned with the remaining aperture in base member 61. Next, rivet 64 is passed through the aperture in flexible member 62 and the remaining aperture in base member 61, and through the material comprising seating apparatus 10. Optionally, seating apparatus 10 comprises a preformed aperture positioned and sized to receive rivet 64. Rivet 64 then is fastened against second surface 66 of seating apparatus 10, thereby fastening base member 61 against first surface 65 of seating apparatus 10, and flexible member 62 against base member 61. Optionally, rivet 64 may be installed from the reverse direction and then fastened against flexible base member 62 to accomplish the same result.

In operation, first end 70 is flexibly displaced toward first surface 65 of seating apparatus 10 at least to the extent sufficient to permit the lifting means to pass between first end 70 of flexible member 62 and first end 67 of base member 61. After the lifting means is engaged inside rounded end 69, first end 70 springs back to its initial position, thereby preventing the lifting means from disengaging with clip 60. FIG. 6B shows a front elevational view of clip 60 with ring 72 of lifting means 81 engaged therewith.

Another type of extraction device is shown in FIG. 6C. FIG. 6C shows a cutaway side view of seating apparatus 10, illustrating the use of an extraction device affixed to the material comprising seating apparatus 10, wherein the extraction device comprises a strap terminating in a ring. Shown in FIG. 6C is seating apparatus 10 comprising a first surface 65, a second surface 66, and a slot 97 communicating between first surface 65 and second surface 66.

Also shown in FIG. 6C is extraction device 90 comprising ring 72, strap 85 having first end 96 and second end 98, rivets 88 and 92, and washers 89 and 91. Ring 72 comprises a small ring of a substantially rigid material such as steel or a substantially rigid plastic or polycarbonate material. Strap 85 comprises a woven nylon material or other material with comparable tensile strength. Washers 89 and 91 each comprise a thin appliance comprising a substantially rigid material such as steel or a substantially rigid plastic or polycarbonate material. Washers 89 and 91 each further comprise an aperture (not shown in FIG. 6C) positioned and sized to receive rivets 88 and 92, respectively. Washers 89 and 91 are optional and may be omitted at the discretion of the practitioner. In addition, if the practitioner so chooses, a single appliance comprising apertures positioned and sized to receive rivets 88 and 92 and further comprising a opening aligned with slot 97 of seating apparatus 10 may be substituted for washers 89 and 91.

To construct extraction device 90, first end 96 of strap 85 is passed through the center of ring 72 and then aligned with second end 98 of strap 85, thereby causing strap 85 to be folded into a substantial U-shape, with ring 72 captured within the folded end of strap 85. One half of folded strap 85 thus comprises leg 100 terminating in first end 96, and the other half of folded strap 85 thus comprises leg 102 terminating in second end 98. A portion of a surface of leg 100 then is joined to a corresponding adjacent portion of a surface of leg 102, such as by sewing or by use of an adhesive. Leg 100 is joined to leg 102 in a manner which creates loop 104 with ring 72 captured therein, but leaves first end 96 separable from second end 98.

Extraction device 90 is affixed to seating apparatus 10 by passing first end 96 and second end 98 of strap 85 through slot 97. First end 96 and second end 98 then are folded in opposite directions until a surface of leg 100 and a surface of leg 102 each engage against first surface 65. In an embodiment where washers 89 and 91 are used, a first surface of washer 89 is engaged against first surface 65 of seating apparatus 10, and the surface of leg 102 then is engaged against a second opposite surface of washer 89, as shown in FIG. 6C. Similarly, a first surface of washer 91 is engaged against first surface 65 of seating apparatus 10, and the surface of leg 100 then is engaged against a second opposite surface of washer 91, as shown in FIG. 6C.

Next, rivet 88 is passed through seating apparatus 10, washer 89, and leg 102 of strap 85 by means well known in the art such as, for example, by use of a rivet gun. Optionally, seating apparatus 10 and leg 102 each comprise a preformed aperture positioned and sized to receive rivet 88. Rivet 88 then is fastened against leg 102, thereby fastening leg 102 against washer 89, and washer 89 against first surface 65 of seating apparatus 10. Optionally, rivet 88 may be passed through leg 102, washer 89, and seating apparatus 10, and then fastened against second surface 66 of seating apparatus 10 to accomplish the same result.

Likewise, rivet 92 is passed through seating apparatus 10, washer 91, and leg 100 of strap 85 by means well known in the art such as, for example, by use of a rivet gun. Optionally, seating apparatus 10 and leg 100 each comprise a preformed aperture positioned and sized to receive rivet 92. Rivet 92 then is fastened against leg 100, thereby fastening leg 100 against washer 91, and washer 91 against first surface 65 of seating apparatus 10. Optionally, rivet 92 may be passed through leg 100, washer 91, and seating apparatus 10, and then fastened against second surface 66 of seating apparatus 10 to accomplish the same result.

FIG. 6D shows a front elevational view of extraction device 90 with clip 60 of lifting means 82 engaged therewith. Extraction device 90 comprises ring 72 and strap 85, wherein strap 85 is protruding through slot 97.

A practitioner of the present invention may find it desirable to ruggedize regions of the seating apparatus adjacent to the extraction points. Where an extraction point comprises an aperture through the seating apparatus, a ruggedizing layer of thermoplastic material may be added around the perimeter of the extraction point aperture. Where an extraction point comprises an extraction device or other extraction means affixed to a surface of the seating apparatus, the ruggedizing piece may be installed adjacent to and/or in contact with the extraction device or the extraction means, in a manner determined by the practitioner to improve the ruggedness of the extraction point without compromising the function of the extraction device or the extraction means. It is possible that such a ruggedizing layer may be install in such a way as to enhance the bonding strength between the extraction device or extraction means and the seating apparatus surface. Where the extraction device or extraction means is affixed to the seating apparatus by a fastening technique such as riveting, the area surrounding the aperture made through the seating apparatus to install the rivet may be ruggedized to inhibit fraying, tearing, or degradation of the seating apparatus material which could reduce the fastening strength of the rivet.

An example of a ruggedized extraction point is shown in FIG. 6C. In FIG. 6C ruggedizing layer 87 is shown. Ruggedizing layer 87 comprises a sheet of thermoplastic material, preferably of the type comprising seating apparatus 10, sized to ruggedize a localized area comprising the extraction point. As previously described herein, ruggedizing layer 87 is heated and then applied to first surface 65 of seating apparatus 10 such that ruggedizing layer 87 covers the extraction point, and an area of one surface of ruggedizing layer 87 bonds to first surface 65 of seating apparatus 10.

Optional leg securing means may be affixed to the seating apparatus near lower edge 11. Leg securing means operate to secure the occupant's legs to the seating apparatus. The leg securing means may comprise straps such as, for example, straps comprising a woven nylon material or other material with comparable tensile strength. In one implementation, leg securing means are affixed to the seating apparatus to the left and right of the occupant and, when used, are fastened across the occupant's legs using VELCRO® or other fastening means known in the art. In another implementation, leg securing means are affixed to the seating apparatus to the left and right of the occupant and between occupant's legs and, when used, are fastened across each of the occupant's legs using VELCRO® or other fastening means known in the art.

Optional thorax securing means comprising straps such as, for example, straps comprising a woven nylon material or other material with comparable tensile strength may be affixed to the seating apparatus near upper edge 12. Thorax securing means serve to secure the occupant's thorax to the seating apparatus. In one implementation, thorax securing means are affixed to the seating apparatus to the left and right of the occupant and, when used, are passed under each of occupant's arms and fastened across the occupant's chest using VELCRO® or other fastening means known in the art.

The optional leg securing means and optional thorax securing means reduce the possibility of the occupant moving relative to the seating apparatus during extraction of the occupied seating apparatus from the seat of the racing automobile or other vehicle.

In operation, when the seating apparatus must be removed from a vehicle with the occupant remaining therein, a lifting means is engaged with each of the plurality of extraction points. The lifting means comprises a strap, rope, chain, hook, or like device. The lifting means may be fabricated from one of many materials known in the art having a strength collectively sufficient to support the weight of the seating apparatus and its human occupant during lifting. In one embodiment, the lifting means comprises a strap comprising a woven nylon material or other material with comparable tensile strength. Where the extraction points are manually engageable, the lifting means may comprise one or more human beings.

In one implementation of the present invention where the extraction points comprise apertures, each lifting means comprises a first end and a second end. The lifting means may be engaged with the apertures by passing the first end of the lifting means through the apertures. The first end and the second end of the lifting means then are secured to prevent the lifting means from unintentionally disengaging from the aperture during extraction of the occupied seating apparatus. Extraction is commenced by applying a lifting force to each of the lifting means. The lifting force may be applied to the lifting means by any means known in the art for applying a lifting force, such as, for example, by use of lifting machinery or by activity of one or more human beings. Additional lifting force may be employed to supplement the lifting force applied to the lifting means, including lifting force engaging the occupant below lower edge 11, and/or lifting force engaging the occupant above upper edge 12.

Where the extraction points comprise extraction devices such as snaps, hooks, clips, VELCRO® fasteners, or other extraction means, each lifting means comprises at least one end engageable with the extraction device or extraction means. Optionally, one end of the lifting means may be integral with the extraction points and therefore permanently attached to the seating apparatus, but this is not preferred.

In one embodiment, a lifting harness may be used. The lifting harness comprises a device able to simultaneously engage a plurality of extraction points. After engagement with the plurality of extraction points, a lifting force is applied to one or more “lifting points” on the lifting harness. The lifting force may be applied to the lifting points by any means known in the art for applying a lifting force, such as, for example, by use of lifting machinery or by activity of one or more human beings. The lifting force is transmitted through the lifting harness into the engaged extraction points, causing the occupied seating apparatus to be lifted.

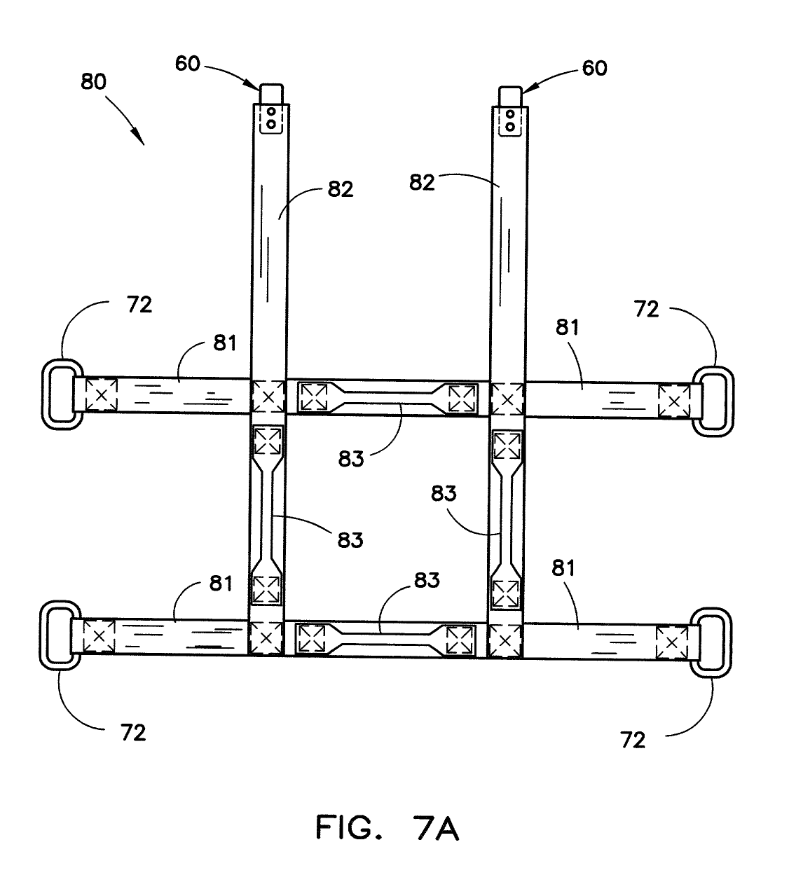

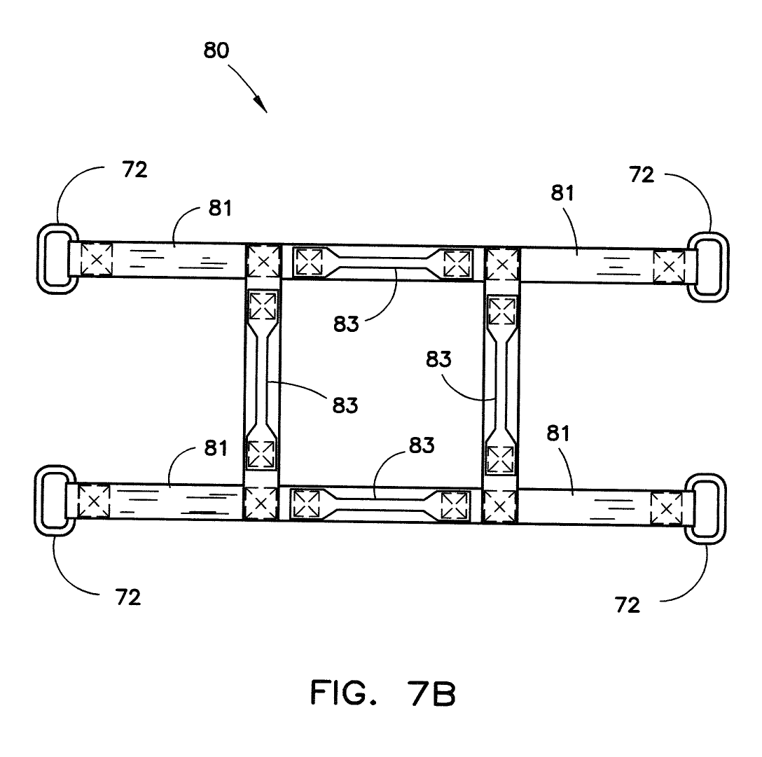

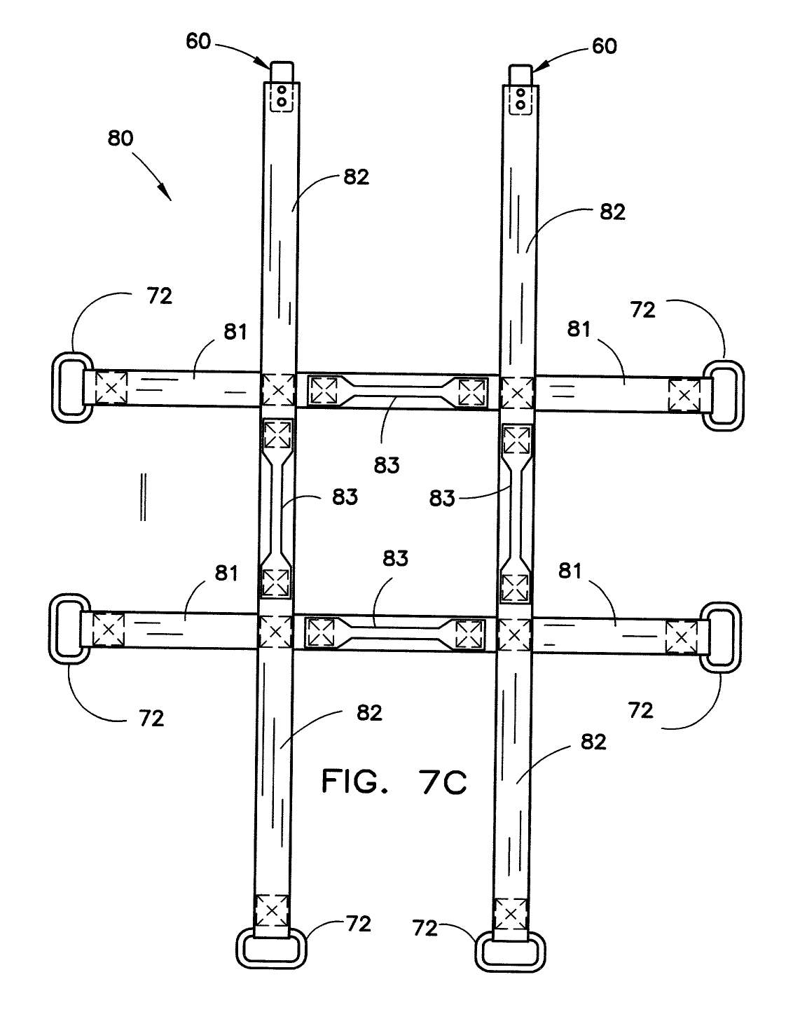

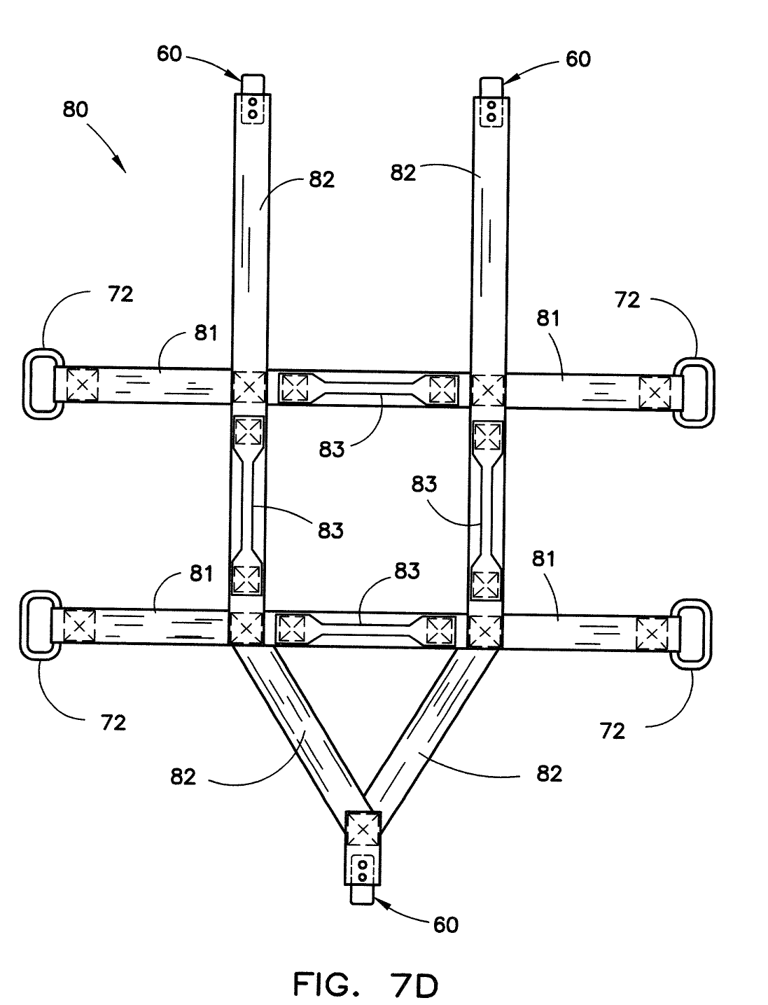

FIGS. 7A-D show top views of several different embodiments of a lifting harness 80 according to the present invention. Each embodiment of lifting harness 80 shown in FIG. 7A-D comprises a plurality of lateral lifting means 81, a plurality of longitudinal lifting means 82, and a plurality of lifting points 83. In the embodiments shown in FIGS. 7A-D, each lateral lifting means 81 and longitudinal lifting means 82 comprises a woven nylon material (or another material known in the art having a comparable tensile strength) terminating in one or more ends engageable with the extraction device chosen by the practitioner.

The embodiments shown in FIGS. 7A-D show the use of ring 72 at the end of each lateral lifting means 81, and the use of clip 60 at the end of each longitudinal lifting means 82. Each ring 72 at the end of each lateral lifting means 81 is engageable with an extraction device such as clip 60 of FIG. 6B. Each clip 60 at the end of each longitudinal lifting means 82 is engageable with an extraction device such as extraction device 90 of FIG. 6D.

Each ring 72 is attached to each lifting means 81 by passing the end of the lifting means through ring 72, and then fixedly securing the lifting means against itself such as by sewing or by bonding with an adhesive or by the use of other securing means known in the art.

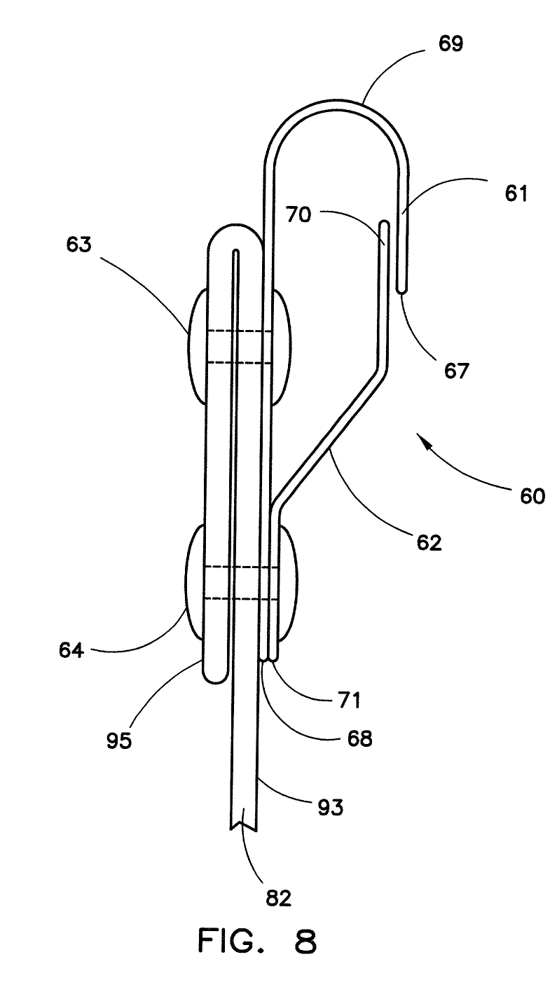

Each clip 60 is attached to each lifting means 82 by one of several means known in the art, including, for example, by riveting. FIG. 8 shows a cutaway side view of lifting means 82, illustrating the clip attached to the material comprising lifting means 82 by riveting. Shown in FIG. 8 are lifting means 82, and clip 60 as previously shown in FIG. 6A, comprising base member 61, flexible member 62, and rivets 63 and 64. Base member 61 comprises apertures (not shown in FIG. 6A) positioned and sized to receive rivets 63 and 64. Flexible member 62 comprises an aperture (not shown in FIG. 6A) positioned and sized to receive rivet 64. Lifting means 82 is folded into a substantial U-shape, wherein the folded lifting means 82 comprises first leg 93 and second leg 95. Second leg 95 has length at least greater than the distance between rivet 63 and rivet 64.

Clip 60 is attached to lifting means 82 by engaging base member 61 against a surface of first leg 93 of seating apparatus 10. Next, rivet 63 is passed through an aperture in base member 61 and through first leg 93 and second leg 95 by means well known in the art such as, for example, by use of a rivet gun. Optionally, first leg 93 and second leg 95 each comprises a preformed aperture positioned and sized to receive rivet 63. Rivet 63 then is fastened against a surface of second leg 95, thereby fastening base member 61 against first leg 93. Optionally, rivet 63 may be installed from the reverse direction and then fastened against base member 61 to accomplish the same result.

Flexible member 62 then is engaged against base member 61 so that the aperture in flexible member 62 is aligned with the remaining aperture in base member 61. Next, rivet 64 is passed through the aperture in flexible member 62 and the remaining aperture in base member 61, and through first leg 93 and second leg 95. Optionally, first leg 93 and second leg 95 each comprises a preformed aperture positioned and sized to receive rivet 64. Rivet 64 then is fastened against a surface of second leg 95, thereby fastening base member 61 against first leg 93. Optionally, rivet 64 may be installed from the reverse direction and then fastened against flexible member 62 to accomplish the same result.

Referring back to FIGS. 7A-D, the lateral lifting means 81 and longitudinal lifting means 82 are joined together at points of intersection, such as by sewing or by bonding with an adhesive. Where the lifting force to be applied comprises the activity of one or more human beings, each of the plurality of lifting points 83 comprises a handle engageable with a human hand, as shown in FIGS. 7A-D. In other embodiments where the lifting force is applied by the use of lifting machinery, the lifting points 83 may comprise one or more rings, snaps, hooks, clips, chains, or other appliance engageable with the lifting machinery.

The embodiment of lifting harness 80 shown in FIG. 7A may be used with many extraction point configurations, including, for example, the extraction point configuration shown in FIG. 5A, or the extraction point configuration shown in FIG. SB. During use of this embodiment of lifting harness 80 with a seating apparatus comprising the extraction point configuration shown in FIG. 5A or in FIG. 5B, rings 72 at each end of each lateral lifting means 81 are engaged with extraction points 53, 54, 55, and 56 shown in FIG. 5A or in FIG. 5B, with one ring 72 engaging each extraction point. Likewise, clips 60 at the end of each longitudinal lifting means 82 are engaged with extraction points 51 and 52 shown in FIG. 5A or in FIG. 5B, with one clip 60 engaging each extraction point. After engaging the extraction points, the occupied seating apparatus is lifting from the automobile by applying a lifting force to one or more of the lifting points 83. At the discretion of the practitioner, additional extraction points may be provided on seating apparatus 10, such as, for example, extraction points comprising handles engageable with a human hand. When using an embodiment of lifting harness 80 such as that shown in FIG. 7A, a practitioner may find it useful to provide one or more extraction points comprising handles near lower edge 11 of seating apparatus 10.

The embodiment of lifting harness 80 shown in FIG. 7B may be used with many extraction point configurations, including, for example, the extraction point configuration shown in FIG. 5A, or the extraction point configuration shown in FIG. 5B. During use of this embodiment of lifting harness 80 with a seating apparatus comprising the extraction point configuration shown in FIG. 5A or in FIG. 5B, rings 72 at each end of each lateral lifting means 81 are engaged with extraction points 53, 54, 55, and 56 shown in FIG. 5A or in FIG. 5B, with one ring 72 engaging each extraction point. After engaging the rings with the extraction points, the occupied seating apparatus is lifting from the automobile by applying a lifting force to one or more of the lifting points 83. At the discretion of the practitioner, additional extraction points may be provided on seating apparatus 10, such as, for example, extraction points comprising handles engageable with a human hand. When using and embodiment of lifting harness 80 such as that shown in FIG. 7B, a practitioner may find it useful to provide one or more extraction points comprising handles near lower edge 11 and/or near upper edge 12 of seating apparatus 10.

The embodiment of lifting means 80 shown in FIG. 7C may be used with many extraction point configurations, including, for example, the extraction point configuration shown in FIG. 5A wherein extraction points 57 and 58 comprise clips. During use of this embodiment of lifting harness 80 with a seating apparatus comprising the extraction point configuration shown in FIG. 5A, rings 72 at each end of each lateral lifting means 81 are engaged with extraction points 53, 54, 55, and 56 shown in FIG. 5A, with one ring 72 engaging each extraction point. Clips 60 at one end of each longitudinal lifting means 82 are engaged with extraction points 51 and 52 of FIG. 5A, with one clip 60 engaging each extraction point. Rings 72 at the opposite end of each longitudinal lifting means 82 likewise are engaged with extraction points 57 and 58 of FIG. 5A, with one ring 72 engaging each extraction point. After engaging the extraction points, the occupied seating apparatus is lifting from the automobile by applying a lifting force to one or more of the lifting points 83. At the discretion of the practitioner, additional extraction points may be provided on seating apparatus 10, such as, for example, extraction points comprising handles engageable with a human hand. When using an embodiment of lifting harness 80 such as that shown in FIG. 7C, a practitioner may find it useful to provide one or more extraction points comprising handles near lower edge 11 and/or near upper edge 12 of seating apparatus 10.

The embodiment of lifting means 80 shown in FIG. 7D may be used with many extraction point configurations, including, for example, the extraction point configuration shown in FIG. 5B wherein extraction point 59 comprises a ring. During use of this embodiment of lifting harness 80 with a seating apparatus comprising the extraction point configuration shown in FIG. 5B, rings 72 at each end of each lateral lifting means 81 are engaged with extraction points 53, 54, 55, and 56 shown in FIG. 5B, with one ring 72 engaging each extraction point. Clips 60 at each end of each longitudinal lifting means 82 are engaged with extraction points 51, 52, and 59 shown in FIG. 5B, with one clip 60 engaging each extraction point. After engaging the extraction points, the occupied seating apparatus is lifting from the automobile by applying a lifting force to one or more of the lifting points 83. At the discretion of the practitioner, additional extraction points may be provided, such as, for example, extraction points comprising handles engageable with a human hand. When using and embodiment of lifting harness 80 such as that shown in FIG. 7D, a practitioner may find it useful to provide one or more extraction points comprising handles near lower edge 11 and/or near upper edge 12 of seating apparatus 10.

In each embodiment of lifting harness 80 shown in FIGS. 7A-D, each ring 72 is shown as being sewn onto the end of the lifting means to which it is attached. Each clip 60 is shown as being riveted onto the end of the lifting means to which it is attached. Thus, the length of each lateral lifting means 81 and longitudinal lifting means 82 in the embodiments shown in FIGS. 7A-D is fixed. However, it is within the scope of the present invention that the length of each lateral lifting means 81 and/or each longitudinal lifting means 82 is adjustable. For example, instead of sewing each ring 72 onto the end of a lifting means, the end of the lifting means may be passed through ring 72 and releasably secured against itself such as by the use of a buckle, or by the use of VELCRO®, or by the use of other securing means known in the art. The attachment of each clip 60 to a lifting means also may be adapted to make the lifting means adjustable. Thus, the lifting means may be adjusted to more securely confine the occupant within the seating apparatus when the occupied seating apparatus is removed from an automobile by increasing or decreasing the length of the lifting means, further reducing the possibility of movement of the occupant relative to the seating apparatus during removal.

It will be appreciated by those skilled in the art that the seating apparatus of the present invention may be readily adapted for use in many forms of vehicles other than racing automobiles, such as, for example, vehicles adapted for street use including passenger automobiles, passenger trucks, mini-vans, vans, busses, and sports-utility vehicles, as well as aircraft and spacecraft. Because customizing the seating apparatus of the present invention to fit the anatomy of each occupant and/or passenger of such vehicles may be impractical and uneconomic, high-volume production techniques may be employed. The production steps of providing a seating apparatus template, heating the template, forming the template, and cooling the template as shown in FIG. 4 are employed, but are adapted for high-volume production. For example, the forming step may be accomplished through the use of machinery designed, tooled, and programmed to form the seating apparatus template to fit a variety of passenger automobile seating configurations and a broad spectrum of human anatomical shapes and sizes.

The present invention is a novel seating apparatus providing significant advantages over the prior art. A seating apparatus according to the present invention is economic to manufacture and lightweight, yet is rigid enough that when lifted at appropriate points, it will support the weight of an injured occupant without substantially flexing. Use of a seating apparatus according to the present invention enables a racetrack safety crew to readily remove an injured race driver, without requiring post-injury maneuvering of the injured race driver for placement of an extraction aid. Because the occupant is seated in the seating apparatus as he or she operates a racing automobile, the seating apparatus is in place and ready for use in the event of an accident involving injury to the occupant, reducing or eliminating injury exacerbation which may arise from post-injury maneuvering of the injured occupant during extraction. In addition, pre-placement of the seating apparatus, in combination with the use of extraction points and lifting means according to the present invention, may significantly reduce the time required to extract an injured occupant, permitting prompt medical attention to the occupant's injuries. Finally, where the seating apparatus of the present invention comprises a thermoplastic material, the inherent resiliency of the material provides an impact absorption function to supplement the impact absorption of the seat in which it resides, benefiting the occupant in an accident or crash.

While this invention has been described as having a preferred design, the present invention can be further modified within the scope and spirit of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. An apparatus for supporting an occupant seated in the apparatus in a vehicle, comprising:
a sheet of a thermoplastic material formed into a substantially L-shaped structure which anatomically fits the occupant, the sheet beginning at a lower edge beneath the occupant, extending continuously beneath and behind the occupant, and terminating at an upper edge behind the occupant; and
a plurality of extraction points integral to the sheet of the thermoplastic material, the extraction points being sufficient in number and appropriately positioned to permit extraction of the occupied apparatus from the vehicle with minimal movement of the occupant relative to the apparatus during extraction.

2. The apparatus of claim 1, wherein the vehicle is a racing automobile.

3. The apparatus of claim 1, wherein the occupant has a thorax having a right side and a left side, and wherein the sheet of the thermoplastic material anatomically formed to fit the occupant further comprises a right thoracic lobe disposed to the right side of the occupant's thorax and a left thoracic lobe disposed to the left side of the occupant's thorax.

4. The apparatus of claim 3, wherein a surface of each of the left thoracic lobe and the right thoracic lobe is engaged against the respective sides of occupant's thorax.

5. The apparatus of claim 1, further comprising a plurality of lifting means removeably engaged with the plurality of extraction points.

6. The apparatus of claim 1, further comprising a lifting harness removeably engaged with at least one of the plurality of extraction points, wherein the lifting harness comprises:
a plurality of lifting means joined together; and
at least one lifting point on the plurality of joined lifting means.

7. The apparatus of claim 6, wherein each of the plurality of lifting means comprises at least one end removeably engaged with at least one of the plurality of extraction points.

8. The apparatus of claim 1, wherein at least one of the plurality of extraction points is engageable with a human hand.

9. The apparatus of claim 1, wherein at least one of the plurality of extraction points comprises an extraction device.

10. The apparatus of claim 1, wherein at least one of the plurality of extraction points comprises a clip.

11. The apparatus of claim 9, wherein at least two of the plurality of extraction points comprise extraction devices, further comprising a lifting harness comprising:
a plurality of lifting means joined together, each of the plurality of lifting means comprising at least one end engageable with one of the extraction devices, wherein at least one lifting means is removably engaged with at least one of the extraction devices; and
at least one lifting point on the plurality of joined lifting means.

12. An apparatus for supporting a human occupant seated in the apparatus in a racing automobile, wherein the human occupant has a back, shoulders, buttocks, and a thorax having a left side and a right side, the apparatus comprising:
a sheet of a thermoplastic material formed to anatomically fit the occupant, the sheet beginning at a lower edge beneath the buttocks of the occupant, extending continuously beneath extraction devices and behind the back of the occupant, and terminating at an upper edge approximately even with the shoulders of the occupant, and having a right thoracic lobe disposed to the right side of the occupant's thorax and a left thoracic lobe disposed to the left side of the occupant's thorax;
a plurality of extraction points integral to the sheet of the thermoplastic material, the extraction points being sufficient in number and appropriately positioned to permit extraction of the occupied apparatus from the vehicle with minimal movement of the occupant relative to the apparatus during extraction; and
a lifting harness removeably engaged with at least one of the plurality of extraction points, the lifting harness comprising:
a plurality of lifting means joined together; and
at least one lifting point affixed to at least one of the plurality of lifting means, the at least one lifting point comprising a handle engageable with a human hand.

13. The apparatus of claim 12, wherein the plurality of extraction points comprises:
one or more extraction devices positioned near the upper edge of the sheet of the thermoplastic material;
one or more extraction devices positioned near the right thoracic lobe;
one or more extraction devices positioned near the left thoracic lobe; and
one or more handles positioned near the lower edge of the sheet of the thermoplastic material;
and wherein the lifting harness comprises:
one or more lifting means each comprising a woven nylon strap having at least one end engageable with the extraction devices positioned near the upper edge of the sheet of the thermoplastic material;
one or more lifting means each comprising a woven nylon strap having at least one end engageable with the extraction devices positioned near the right thoracic lobe; and
one or more lifting means each comprising a woven nylon strap having at least one end engageable with the extraction devices positioned near the left thoracic lobe.

14. A method for making a seating apparatus comprising the steps of:
providing a seating apparatus template comprising a sheet of a thermoplastic material;
exposing the seating apparatus template to a heat source causing the temperature of the seating apparatus template to be elevated to at least above the temperature at which the thermoplastic material comprising the seating apparatus template becomes formable;
forming the seating apparatus template;
cooling the seating apparatus template to a temperature below which the thermoplastic material comprising the seating apparatus template no longer is formable; and
adding a plurality of extraction points to the seating apparatus template.

15. The method of claim 14, wherein the seating apparatus template is formed to fit the anatomy of an eventual occupant.

16. The method of claim 15, wherein the eventual occupant comprises a torso, lower extremities, and a body weight, wherein the seating apparatus template comprises an anterior template surface and a posterior template surface, the anterior template surface and the posterior template surface being substantially parallel and separated by the thickness of the sheet of the thermoplastic material, and wherein the step of forming the seating apparatus template to fit the anatomy of the eventual occupant comprises the steps of:
placing the seating apparatus template over an automobile racing seat with the posterior template surface facing a seating surface of the automobile racing seat;
engaging the torso and the lower extremities of the eventual occupant against the anterior template surface; and
applying the body weight of the eventual occupant against the anterior template surface until the posterior template surface engages the seating surface of the automobile racing seat, thereby causing the posterior template surface to become deformed convexly and the anterior template surface to become deformed concavely.

17. The method of claim 15, wherein the eventual occupant comprises a thorax, wherein the seating apparatus template comprises at least one thoracic template lobe having an anterior template lobe surface, and wherein the step of forming the seating apparatus template to fit the anatomy of the eventual occupant comprises the step of:
applying forming pressure to the at least one thoracic template lobe causing the anterior template lobe surface thereof to become engaged against the occupant's thorax.

18. The method of claim 17, wherein the thorax has a right side and a left side, and wherein the seating apparatus template comprises a right thoracic lobe and a left thoracic lobe, further comprising the step of:
applying forming pressure to the right thoracic lobe and the left thoracic lobe until the anterior surface of the right thoracic lobe is engaged against the right side of the occupant's thorax, and the anterior surface of the left thoracic lobe is engaged against the left side of the occupant's thorax.

19. A method for making a seating apparatus comprising the steps of:
providing a seating apparatus template comprising a sheet of a thermoplastic material;
exposing the seating apparatus template to a heat source causing the temperature of the seating apparatus template to be elevated to at least above the temperature at which the thermoplastic material comprising the seating apparatus template becomes formable;
providing a human occupant for the seating apparatus, the occupant having buttocks and a back;
forming the seating apparatus template into a continuous structure which fits the buttocks and the back of the occupant; and
cooling the seating apparatus template to a temperature below which the thermoplastic material comprising the seating apparatus template no longer is formable.

20. The method of claim 19, further comprising the step of:
adding a plurality of extraction points to the seating apparatus template.
